(19) United States
(12) Patent Application Publication
(10) Pub. No.: US 2013/0290383 A1
(43) Pub. Date: Oct. 31, 2013

(54) MAPPING LONG NAMES IN A FILESYSTEM

(71) Applicants: Jain Nitin, Meerut (IN); Eric A Anderson, Mountation View, CA (US); Joseph A. Tucek, Palo Alto, CA (US)

(72) Inventors: Jain Nitin, Meerut (IN); Eric A Anderson, Mountation View, CA (US); Joseph A. Tucek, Palo Alto, CA (US)

(21) Appl. No.: 13/460,167

(22) Filed: Apr. 30, 2012

(51) Int. Cl. G06F 17/30

(52) U.S. Cl. 707/822; 707/E17.01

(57) ABSTRACT

Mapping long names in a filesystem is disclosed. An example method includes hashing a long file name, and storing a file with the hashed file name. Another example method includes splitting a long file name into at least two parts, and encoding the at least two parts of the long file name as directory structures in the filesystem.

### BACKGROUND

Filesystems are used in computing environments to manage (e.g., read, write, and update) data by maintaining the physical locations of data on storage devices such as hard disk drives, optical discs, and flash storage devices. The filesystem ensures reliability of the data. Filesystems may also provide access to data on a network device (e.g., server or storage system). Filesystems employ a naming convention for organizing the data.

Filesystems typically have a limit to how large of a filename that can be used. A typical maximum filename size is 255 bytes. Creating filenames larger than the specified size can return an error such as “File name too long.” In addition, Unicode Transformation Format (UTF-8), a character coding system which can encode international character sets, uses multi-byte sequences to represent characters not found in typical single-byte encodings. A multi-byte sequence may be used to represent a single international character. Accordingly, a foreign language filename is even more likely to cross the 255 byte boundary.

### BRIEF DESCRIPTION OF THE DRAWINGS

FIG. 1 is a high-level illustration of mapping long names in a filesystem.

FIG. 2 is a process flow diagram illustrating example operations for mapping long names in a filesystem.

FIG. 3 is another process flow diagram illustrating example operations for mapping long names in a filesystem.

FIG. 4 is another process flow diagram illustrating example operations for mapping long names in a filesystem.

FIG. 5 is another process flow diagram illustrating example operations for mapping long names in a filesystem.

FIGS. 6a and 6b are flowcharts illustrating example operations which may be implemented for mapping long names in a filesystem.

### DETAILED DESCRIPTION

Filesystems may limit the number of characters (i.e., length) of file names. For example, many filesystems limit file names to no more than 255 bytes. The use of non-ASCII characters (e.g., international characters) may impose even lower limits on the number of characters a filename can have, depending at least in part on the encoding scheme. For example, file names that have Chinese characters may be limited to less than 64 characters when encoded using UTF-8.

By way of illustration, while the following filename is very descriptive for a photograph file, and thus may be desirable by the user, the user would not be permitted to use this filename in a Unix filesystem using UTF-8 encoding, because it includes 340 characters (exceeding the 255 byte limit):
Archive:Backups from old machine:2006:June 23:Thomas Smith's Stuff:Pictures:Vacations:Older Stuff:Mexico 1992:Alcapoluco:Picture of Thomas Smith, Richard Black, Harold Brown, Mary Smith, Jimmie Smith, and Emma Black sitting at the pool after a long day at the beaches.jpg

Some older filesystems, notably the File Allocation Table (FAT) file system (created by Microsoft Corporation in 1977) and follow-on family of filesystems for the Microsoft disk operating system (MS-DOS), only support file names having 11 characters. To address this, Microsoft Corporation developed Long File Names (LFN) which can be stored on a FAT filesystem. An additional entry, or even multiple entries are made before the normal file entry. The additional entries are marked with the Volume Label, System, Hidden, and Read Only attributes.

However, this combination of additional entries is not expected in the MS-DOS environment, and therefore is ignored by MS-DOS programs and third-party utilities. Such a situation appears if files created with long names are deleted from plain DOS. In general these techniques are specific to the design of and oddities in the FAT filesystem family. Even if the techniques could be adapted to another filesystem, the techniques are still dependent on controlling the specific order of directory entries, which cannot be done using generic user-level application programming interfaces (APIs).

The systems and methods disclosed herein may be used for mapping long names in a filesystem. An example method includes hashing a long file name, and storing a file with the hashed file name. Another example method includes splitting a long file name into at least two parts, and encoding the at least two parts of the long file name as directory structures in the filesystem.

Before continuing, it is noted that as used herein, the terms “includes” and “including” mean, but are not limited to, “includes” or “including” and “includes at least” or “including at least.” The term “based on” means “based on” and “based at least in part on.”

In addition, it is noted that the systems and methods described herein may be implemented with any of a wide variety of computing devices, such as, but not limited to, stand-alone desktop/laptop/netbook computers, workstations, server computers, blade servers, mobile devices, and appliances (e.g., devices dedicated to providing a service), to name only a few examples. Each of the computing devices may include memory, storage, and a degree of data processing capability to at least execute the operations described herein as program code. The computing devices may also execute general purpose computing services, application programming interfaces (APIs), and related support infrastructure, such as application engines, and hosted business services.

The computing devices described herein are provided only for purposes of illustration of an example operating environment, and are not intended to limit implementation to any particular system. The systems and methods may be implemented by any suitable computer or computing device and are not limited to any particular type of devices. By way of example, the format 0xHEXCODE may be used as a convention for representing unprintable byte values (e.g., 0xff for the byte value of 255, or 0x7f, which is byte value 127 and is a “delete” character).

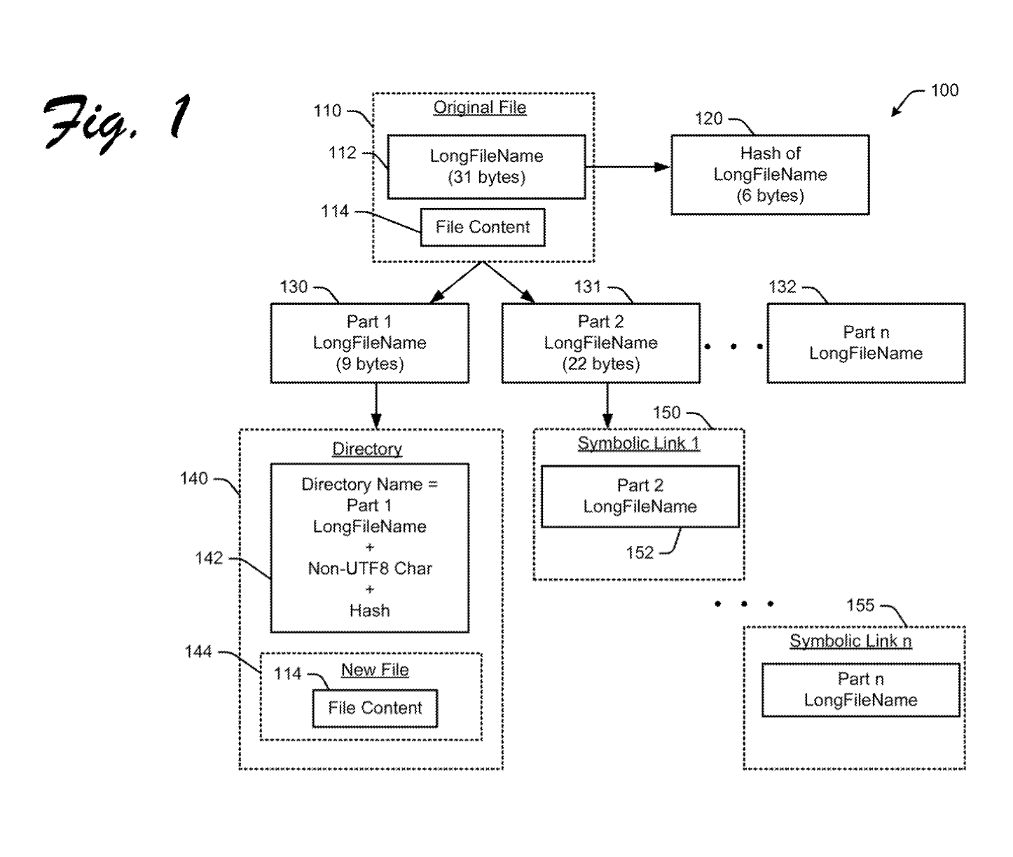

FIG. 1 is a high-level illustration 100 of mapping long names in a filesystem. An original file 110 is shown having a long file name 112 (e.g., 31 bytes) and file content 114. For purposes of this illustration, the maximum file name length is 16 bytes. In an example, a hash 120 is calculated for the long file name 112, and the long file name 112 is divided into a plurality of parts. The first part 130 has a size of the maximum length allowed (e.g., 16 bytes in this example), minus the hash length (e.g., 6 bytes in this example), minus one. Two parts are shown. The first part 130 is 9 bytes and the second part 131 is 22 bytes. The number of parts is based on the length of the file name, and may include more than two parts, as indicated by part n 132.

A directory 140 may be named 142 with the first part 130 of the long file name, plus a non UTF-8 byte sequence (e.g., 0xfe or 0xff), plus the hash. The non-UTF-8 byte sequence is used to distinguish between the normal file name and the long filename; there are many such sequences (e.g., illegal in UTF-8, or referencing codepoints which are unused and likely to remain unused in the future), but the single byte sequences 0xfe and 0xff are the most compact. The directory 140 may also include a new file 144 with the file content 114 from the original file 110. In addition, a symbolic link file has the name 152 of the second part 131 of the long file name. Additional symbolic link file(s) may also be created, as indicated by symbolic link file n 155, based on the number of parts of the long file name (e.g., part n 132).

For reading files, the system computes the directory name and reads the file as “directory name/content”. For listing files, the system reads the complete directory, and for directories with ‘0xfe’, the system reads “directory_name/full_name.” This file includes the full name. If the content is supposed to be a directory, then instead of having the sub-file be named “content,” it may be named “directory”.

In a symbolic link (“symlink”) implementation, it is like hash-chaining (described below), but without the hash bits because the symlink can carry connections between pieces. That is, the system reads “directory_name/symbolic_link” to determine the beginning of the actual filename. The link (symbolic_link) points to another symlink, with the name “ackard-Key-Valu0xff” (where 0xff indicats that there is more to the file name). This one points to a symlink with the name “e-Store,” and may point to “content,” or something invalid, or back to symlink. The entire filename is stored in the chain of symbolic_links. The symlinks are special files which hold a path to something else being pointed to. The maximum length of a symlink is typically on the order of, or the same as, the maximum file name size (although it may be longer).

By way of illustration of the operations shown in FIG. 1, an example file name may be “Hewlett-Packard-Key-Value-Store.” If the maximum file length is 16 bytes, and the hash length is 6 bytes, a hash of the file name is “b7910b.” The file name is split into two parts: “Hewlett-P” and “ackard-Key-Value-Store.”

Accordingly, the directory is named “Hewlett-P0xfeb7910b” and the file content will be stored at:
Hewlett-P0xfeb7910b/content

The symbolic link file “Hewlett-P0xfeb7910b/symbolic_link” stores the second part of the long file name “ackard-Key-Value-Store” as a reference.

To fetch data for the file, the system reads:
Hewlett-P0xfeb7910b/content

To enumerate and retrieve the full long file name, the system reads:
Hewlett-P0xfeb7910b/symbolic_link”

In another example with reference to FIG. 1, the maximum allowed length is 64 bytes. The filename is “Hewlett-Packard-Key-Value-Store-Project-With-Very-Very-Long-FileName” and is 68 bytes long. The UTF-8 encoded filename is:
Hewlett-Packard-Key-Value-Store-Project-With-Very-Very-Long-FileName

The filename is split into multiple parts. Part 1 is “Hewlett-Packard-Key-Value-Store-Project-With-Very-Very-Long-Fil” which is 63 bytes long. Part 2 is “eName.”

The non-UTF-8 byte “0xfe” is added at the end of each part, except the last part. In this example, part 1 is:
Hewlett-Packard-Key-Value-Store-Project-With-Very-Very-Long-Fil0xfe

And part 2 is:
eName

Sub-directories are named for each part and the file content is stored with the file name “last part” under the innermost directory. Thus, the file in this example is stored as:
Hewlett-Packard-Key-Value-Store-Project-With-Very-Very-Long-Fil0xfe/eName

Accordingly, long filenames can be stored, limited only by the maximum number of sub-directories the filesystem can have. It eliminates the need to have a separate mapping, and only uses standard POSIX APIs.

Before continuing, it is noted that the system may be embodied as a computing device executing program code to carry out the operations described herein. The program code may execute the function of the architecture of machine readable instructions as self-contained modules. These modules can be integrated within a self-standing tool, or may be implemented as agents that run on top of an existing program code. In an example, the program code discussed above with reference to FIG. 1 may be implemented in machine-readable instructions (such as but not limited to, software or firmware). The machine-readable instructions may be stored on a non-transient computer readable medium and are executable by one or more processor to perform the operations described herein. However, the operations described herein are not limited to any specific implementation with any particular type of program code. Operations of the program code can be better understood with reference to the following examples of various implementations.

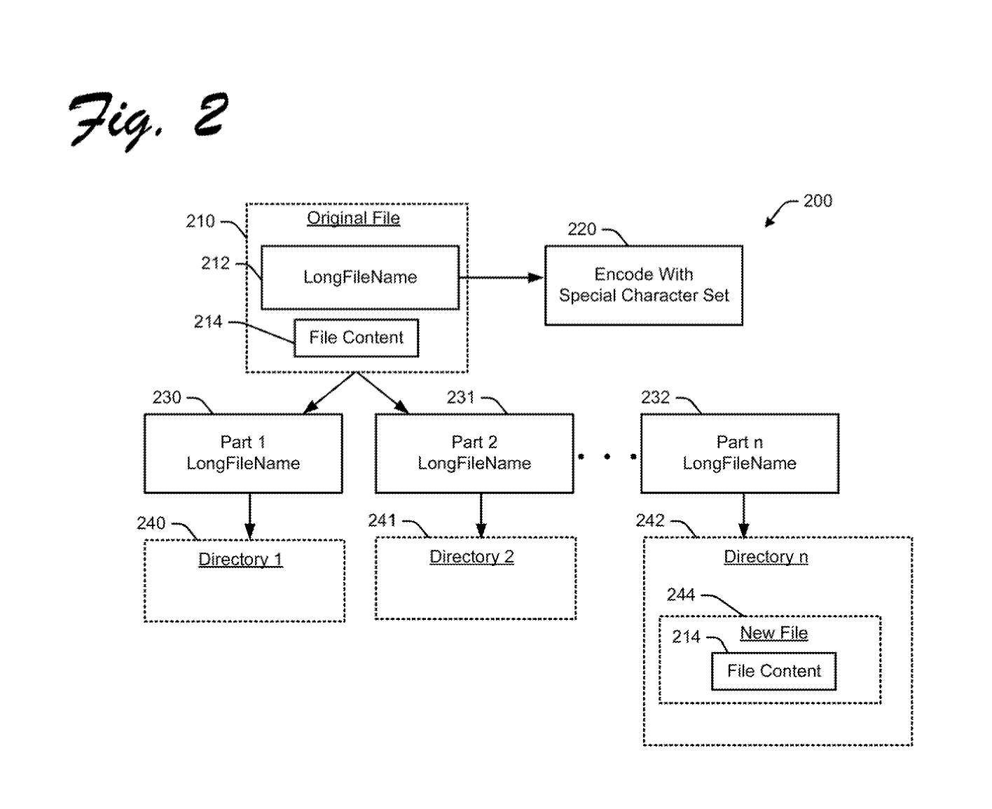

FIG. 2 is another process flow diagram 200 illustrating example operations for mapping long names in a filesystem. This approach is similar to the implementation described above with regard to FIG. 1, and overcomes the maximum number of directory limitation.

An original file 210 is shown having a long file name 212 and file content 214. In an example, the long file name is encoded 220 with a special character set is calculated for the long file name 212, before the long file name 212 is divided into a plurality of parts. For example, the file name may be encoded with base64 with a character set excluding the character ‘/’ and selected in ASCII-betical order (i.e., in ascending or descending order of the ASCII character set). For example, the character list “+,0123456789ABCDEFGHIJKLMNOPQRSTUVWXYZabcdefghijklmnopqrstuv wxyz” is ordered in ascending order. Directories 240-241 are created, one directory after every 2 characters and appended with a character not used in the base-64 encoding (e.g., ‘|’). The number of directories is based on the length of the file name, and may include many parts, as indicated by part 232 and corresponding directory n 242. The file content 214 is stored as a new file 244 in the inner-most directory.

By way of illustration, the maximum allowed file name length is 64 bytes. The file name “Hewlett-Packard-Key-Value-Store-Project-With-Very-Very-Long-FileName” is 68 chars long. The UTF-8 encoded filename is:
Hewlett-Packard-Key-Value-Store-Project-With-Very-Very-Long-FileName

The lintel::ASCII-betical B64 encoded filename is:
G4JrP4JoR0pEMKBfML7Y9IhZSGpKMKIpNGpHR4xmNGpEQaxeNKBo9JRdR4UhJaJmSGpKNL7t9IIjPaQhFaZgNItVPKI

Accordingly, the multiple parts, each of 2 characters long, are:
“G4 Jr P4 Jo R0 pE MK Bf ML 7Y 9I hZ SG pK MK Ip NG pH R4 xm NG pE Qa xe NK Bo 9J Rd R4 Uh Ja Jm SG pK NL 7t 9I Ij Pa Qh Fa Zg NI tV PK I

The corresponding sub-directories are:
G4| Jr| P4| Jo| R0| pE| MK| Bf| ML| 7Y| 9I| hZ| SG| pK| MK| Ip| NG| pH| R4| xm| NG| pE| Qa| xe| NK| Bo| 9J| Rd| R4| Uh| Ja| Jm| SG| pK| NL| 7t| 9I| Pa| Qh| Fa| Zg| NI| tV| PK|

And the file in the inner-most directory would be is “|.” Thus the file is stored as:
G4|/Jr|/P4|/Jo|/R0|/pE|/MK|/Bf|/ML|/7Y|/9I|/hZ|/SG|/pK|/MK|/Ip|/NG|/pH|/R4|/xm|/NG|/pE|/Qa|/xe|/NK|/Bo|/9J|/Rd|/R4|/Uh|/Ja|/Jm|/SG|/pK|/NL|/7t|/9I|/ij|/Pa|/Qh|/Fa|/Zg|/NI|/tV|/PK|/I

This approach can be used to store very long filenames, and is not limited by the maximum number of sub-directories level the file system can have. That is, the limit of reaching a maximum number of directories is overcome by having a directory at every second level. The maximum number of directories needed to store very long filenames is thus 64×64=4096, which is much lower than the maximum limit. It is also noted that this approach can use standard APIs (with a path-name limit). Filenames that are still limited by path length limits, may be accessed through APIs such as “openat.”

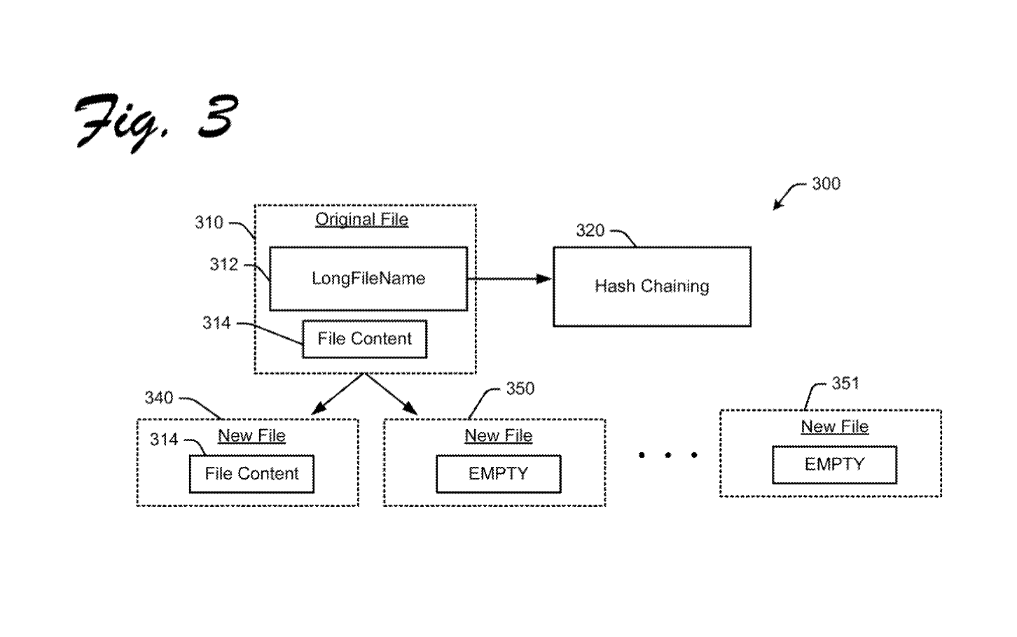

FIG. 3 is another process flow diagram 300 illustrating example operations for mapping long names in a filesystem. An original file 310 is shown having a long file name 312 and file content 314. In an example, the long file name 312 is split into different file names using hash chaining. A hash 320 is calculated for the long file name 312 (e.g., encoding the filename with UTF-8 and replace ‘/’ by Oxff) in an interative process, as described by the following pseudo code (comments are denoted behind the //).

```
  string filename; // the long file name is UTF-8 encoded, and the
character ‘/’ is replaced by 0xff
  int max_allowed_limit; // determine maximum length of the file name
  vector<string> files; // create a vector to store split file names
  while(filename.size( ) > max_allowed_limit) {
    string hash = HASH(filename); // calculate a file name hash
    hash.replace(‘/’, ‘0xff’); // replace ‘/’ with “0xff”
    int file_length = max_allowed_limit − (hash.size( ) + 1); //
  maximum length of each file.
    string current_file = filename.substr(0, file_length) + ‘0xfe’ + hash;
    string next_file = hash + ‘0xfe’ + filename.substr(file_length);
    files.push_back(current_file);
    filename = next_file;
  }
  files.push_back(filename).
```

In another example of hash-chaining, the hash is calculated and the first name is determined the same way as shown above. The remaining names become file-hash+#+0xFE+substring. The # symbols are sequentially increasing numbers for the different sub-parts (e.g., 0 1 2 3 . . . )

In any event, the file names which are generated during the above process may be stored in memory in any of a number of ways. For example, the file content 314 can be stored in the first file 340, and the remaining file names can be stored in any number of empty files 350-351.

In another example, the file content is stored in the first file, and the remaining files only exist to give the name below, have the first two bytes of the name as “.\0xFF” (dot and hexadecimal FF), so that the files are hidden and do not appear as user-created files.

In another example, instead of using empty files, the full file name is stored in “fake” files. It is noted that this raises permissions issues. For example, a user might have WRITE permission on a directory, but not for a file. Thus, when the user renames the file, the user also needs WRITE permission for the file to change the content of the “fake” file which includes the full filename.

In another example, symlinks may be used to chain the extra “name” file names together. Symlinks are portable. Thus, the first file stores the content, and the remaining file(s) are symlinks to the next filename.

For purposes of illustration, the maximum allowed file name length is 64 bytes. An examplefilename is “Hewlett-Packard-Key-Value-Store-Project-With-Very-Very-Long-FileName” and is 68 characters long. The UTF-8 encoded filename is “Hewlett-Packard-Key-Value-Store-Project-With-Very-Very-Long-FileName.”

In loop 1 (referring to the above pseudo code), the hash is calculated as “c7a353d63eacdac0c67526ef6d2401cc.” It is noted that the hash in this example is shown as md5 hex to have printable characters. The hash is 20 bytes long in binary format and the character ‘/’ is replaced by “0xff.” The remainder of Loop 1 is shown below:
file_length=43;
files[0]=Hewlett-Packard-Key-Value-Store-ProjectWit0xfec7a353d63eacdac0c67526ef6d2401cc
filename=c7a353d63eacdac0c67526ef6d2401cc0xfeh-Very-Very-Long-FileName

Out of loop:
files[1]=c7a353d63eacdac0c67526ef6d2401cc0xfeh-Very-Very-Long-FileName

Thus, the file names are:
files[0]=Hewlett-Packard-Key-Value-Store-Project-Wit0xfec7a353d63eacdac0c67526ef6d2401cc
files[1]=c7a353d63eacdac0c67526ef6d2401cc0xfeh-Very-Very-Long-FileName

It is readily apparent that this approach may be used to store long filenames which may be limited by the available resources (e.g., free inodes). Reading a file takes approximately the same amount of time as regular length file names, and the only overhead is in calculating the hash to determine the original long file name. When reading the directory, all filenames with a hash are combined to get the actual filename.

The overhead would be to calculate a different file name and to create extra empty files. The number of extra empty files would depend on the length of the file name. Thus, with an example hash length of 20 bytes, to support a filename of length 486, one extra file needs to be created. After that, for every 213 characters, one extra file is created. In addition, this approach uses standard Portable Operating System Interface (POSIX) APIs.

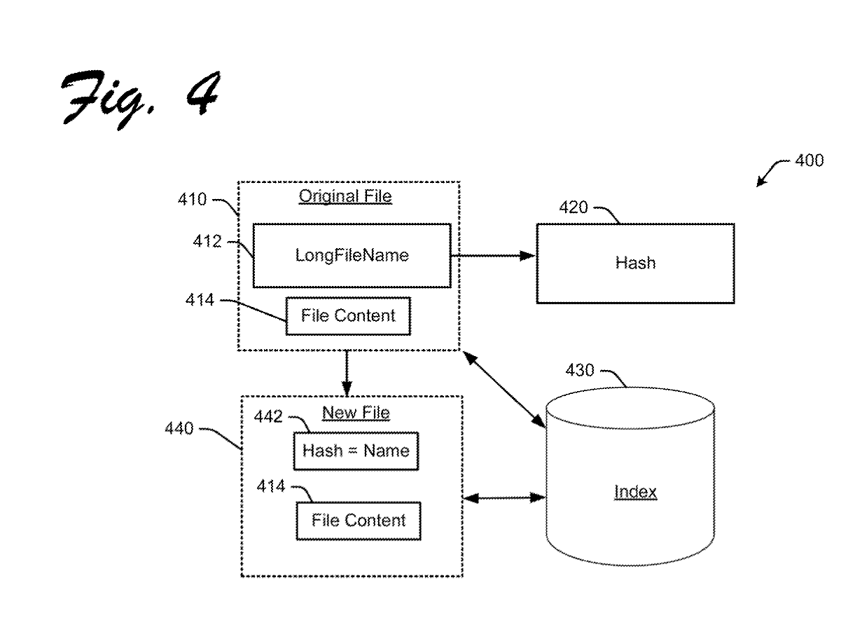

FIG. 4 is a process flow diagram 400 illustrating example operations for mapping long names in a filesystem. An original file 410 is shown having a long file name 412 and file content 414. In an example, a hash 420 is calculated for the long file name 412. The file content 414 is stored in a new file 440 using the hash-value 420 as the filename 442 of the new file 440. A mapping from hash-value to filename can be stored separately in a separate index file 430, key-value store or a database.

For purposes of illustration, the maximum allowed file name length is 64 bytes. The filename is “Hewlett-Packard-Key-Value-Store-Project-With-Very-Very-Long-FileName” (68 characters). The hash value is calculated using md5 hex hashing as:
c7a353d63eacdac0c67526ef6d2401cc

Accordingly, a new file is named:
c7a353d63eacdac0c67526ef6d2401cc

and the following entry is added to the index file as:
C7a353d63eacdac0c67526ef6d2401cc→Hewlett-Packard-Key-Value-Store-Project-With-Very-Very-Long-FileName

Instead of hexadecimal encoding, the hash may be represented in base64, or base85, if the variant of the encoding avoids using the directory separator character “/”. For example, the base85 encoding used in RFC 1924 may be implemented.

This implementation allows very long file names which are only limited by the maximum value that can be stored in the index file. Writing and reading from the index file may be serialized using a locking mechanism for multiple processes to update the file system simultaneously. Entries are managed in the file index whenever a file is added or deleted. Read/write permissions for the index file are managed.

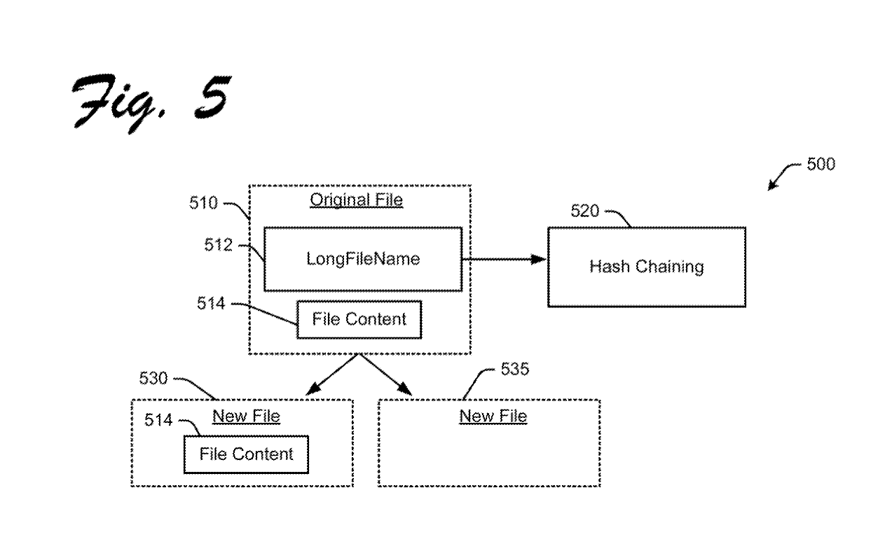

FIG. 5 is another process flow diagram illustrating example operations for mapping long names in a filesystem. This illustration is a variant of the example operations shown in FIG. 4. An original file 510 is shown having a long file name 512 and file content 514. In an example, a hash chain 520 is calculated for the long file name 512, and two files 530-535 are created. The first file 530 (“filename-prefix”-0xff-hash“) stores the file content. The second file 535 (.\0xff-hash) stores the full file name. An index file is not needed for mapping the hash to the file names.

By way of illustration, the maximum allowed file name length is 64 bytes. The long file name is “Hewlett-Packard-Key-Value-Store-Project-With-Very-Very-Long-FileName” and is 68 characters long. The hash value is calculated using md5 hex as:
c7a353d63eacdac0c67526ef6d2401cc

Thus, a file is created to store the file content, with the filename:
Hewlett-Packard-Key-0xffc7a353d63eacdac0c67526ef6d2401cc

Another file is created (which contains the full file name) with the file name:
.\0xffc7a353d63eacdac0c67526ef6d2401cc

It is noted that permissions may need to be modified. For example, renaming a file that the user otherwise only needs write permission on a directory may also require the user to have write permission to implement this approach.

This approach works well with very long filenames. Read and write operations are efficient. In addition, file names on a Unix file system can be of any arbitrary length. This approach does not rely on any special access to the file system, and instead works through standard POSIX APIs. This approach does not impose any inherent limits.

Before continuing, it should be noted that the examples described above are provided for purposes of illustration, and are not intended to be limiting. Other devices and/or device configurations may be utilized to carry out the operations described herein.

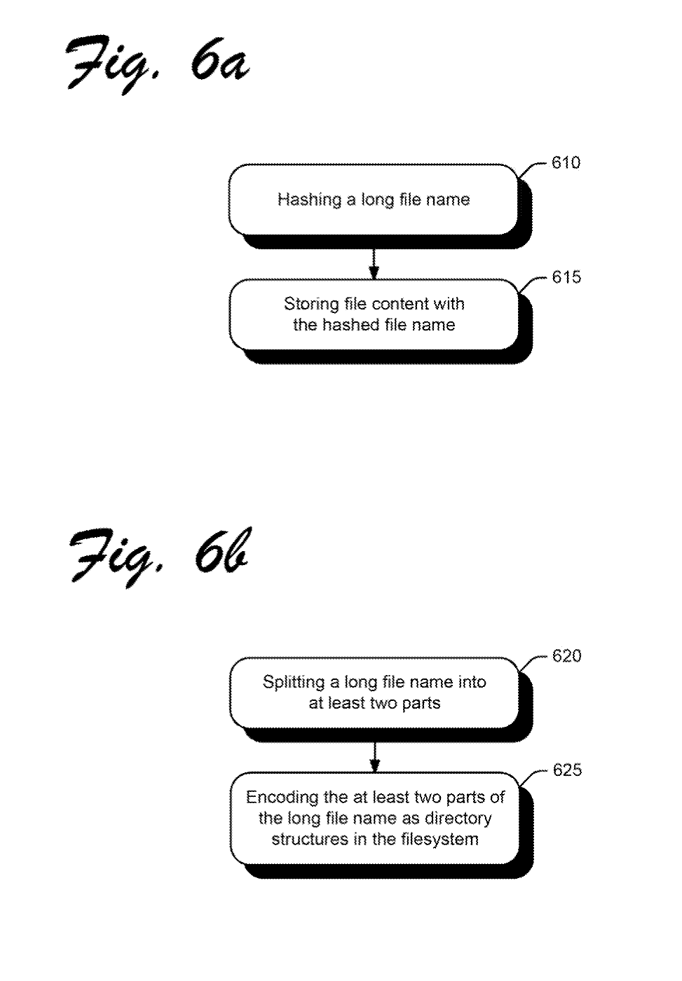

FIGS. 6a and 6b are flowcharts illustrating example operations which may be implemented for mapping long names in a filesystem. The operations may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

In FIG. 6a, operation 610 includes hashing a long file name. Operation 615 includes storing file content with the hashed file name.

In FIG. 6b, operation 620 includes splitting a long file name into at least two parts. Operation 625 includes encoding the at least two parts of the long file name as directory structures in the filesystem. In an example, each of the at least two parts of the long file name has a length equal to a maximum allowed number of bytes minus one. A last one of the at least two parts of the long file name is less than or equal to the maximum allowed number of bytes minus one.

The operations shown and described herein are provided to illustrate example implementations. It is noted that the operations are not limited to the ordering shown. Still other operations may also be implemented, as illustrated above with reference to FIGS. 1-5.

Examples of these other operations for the flow diagram shown in FIG. 6a include, but are not limited to, splitting the long file name into at least two parts using hash chaining. Operations may also include replacing ‘/’ with Oxff in binary format. Operations may also include storing the file content in a first file and creating empty files for remaining file names. Operations may also include storing file content in a first file and remaining file names having first two bytes as ‘dot and hexadecimal 0xFF’ so that the remaining file names are hidden and not mistaken as user-created files. Operations may also include storing full filename in fake files. Operations may also include using symlinks to chain remaining file names together. Operations may also include after hashing the long file name, creating a first file to store file content and a second file to store the long file name.

Examples of these other operations for the flow diagram shown in FIG. 6b include, but are not limited to, using a non-UTF-8 character to distinguish between a normal file name and the long file name. Encoding may comprise creating subdirectories for each of the at least two parts of the long file name. Other operations may include storing file content under an innermost subdirectory. Other operations may include encoding the long file name with a special character set before splitting the long file name. In an example, the special character set excludes ‘/’. Characters may be selected from the special character set in ASCII-betical order. A directory at every second level helps mitigate imposition of a maximum number of directories by the filesystem.

Other operations may include creating a directory after every two characters and appending the directory with a non-base64 character. The non-base64 character may be a ‘|’.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method of mapping long names in a filesystem, comprising:
hashing a long file name; and
storing file content with the hashed file name.

2. The method of claim 1, further comprising splitting the long file name into at least two parts using hash chaining.

3. The method of claim 2, further comprising replacing ‘/’ with bytes not yet used in a legitimate filename.

4. The method of claim 3, wherein the ‘/’ bytes are replaced with 0xff or 0xfe in binary format.

5. The method of claim 2, further comprising storing the file content in a first file and creating empty files for remaining file names.

6. The method of claim 2, further comprising storing the file content in a first file and remaining file names having first two bytes as ‘dot and hexadecimal 0xff or 0xfe’ so that the remaining file names are hidden and not mistaken as user-created files.

7. The method of claim 2, further comprising storing a full filename in fake files.

8. The method of claim 2, further comprising using symbolic links to chain remaining file names together.

9. The method of claim 1, further comprising after hashing the long file name, creating a first file to store file content and a second file to store the long file name.

10. A method of mapping long names in a filesystem, comprising:
splitting a long file name into at least two parts; and
encoding the at least two parts of the long file name as directory structures in the filesystem.

11. The method of claim 10, wherein all but one of the at least two parts of the long file name has a length equal to a maximum allowed number of bytes minus one.

12. The method of claim 11, wherein a last one of the at least two parts of the long file name is less than or equal to the maximum allowed number of bytes minus one.

13. The method of claim 11, further comprising using a non-UTF-8 character to distinguish between a normal file name and the long file name.

14. The method of claim 11, wherein encoding comprises creating subdirectories for each of the at least two parts of the long file name.

15. The method of claim 14, further comprising storing file content under an innermost subdirectory.

16. The method of claim 10, further comprising encoding the long file name with a special character set before splitting the long file name.

17. The method of claim 16, wherein the special character set excludes ‘/’.

18. The method of claim 16, wherein characters are selected from the special character set in ASCII-betical order.

19. The method of claim 16, wherein a directory at every second level mitigates imposition of a maximum number of directories by the filesystem.

20. The method of claim 16, further comprising creating a directory after every two characters and appending the directory with a character not used in the encoding.
